(19) United States
(12) Patent Application Publication
(10) Pub. No.: US 2003/0178952 A1
(43) Pub. Date: Sep. 25, 2003

(54) Cold cathode-ray tube driving method

(76) Inventors: Kazuhiro Miyashita, Kaohsiung City (TW); Yen-Chuan Chu, Kaohsiung City (TW); Ming-Hsiang Yu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/102,701

(22) Filed: Mar. 22, 2002

(51) Int. Cl. H01J 23/16

(52) U.S. Cl. 315/325; 315/3

(57) ABSTRACT

A cold cathode-ray tube driving method by using a voltage with fixed phase shift to drive each cold cathode-ray tube of a backlighting module in a large size LCD; a circuit with phase excursion formed by the voltage so to provide a fixed phase shift between abutted loads to supply a highly consistent power source and to effectively control electricity leakage due to unstable phase shift between abutted loads.

### BACKGROUND OF THE INVENTION

(a) Field of the Invention

The present invention is related to a cold cathode-ray tube driving method applied in carrying multiple cold cathode-ray tubes, and more particularly, to one that is applied in driving cold cathode-ray tubes of a down backlighting module in a large size LCD.

(b) Description of the Prior Art

When a LCD using backlighting module is compared with other types of displays (CRT, PDP), LCD consumes lower power. However, the development of LCD is heading for larger size, the total lightness of the light source from the backlighting module must be relatively increased to cope with the light source required by the LCD. By increasing the glow intensity of the cold cathode-ray tube in the backlighting module or the quantity of the cold cathode-ray tube. Furthermore, generally the backlighting module has its light coming from its side as illustrated in FIG. 1 of the accompanying drawings. Within, a cold cathode-ray tube 2 provided by a light guide plate 1 and a reflector plate 3 is adhered to the bottom of the light guide plate. Multiple light diffusion films 4 are separately provided on the illuminating side of the light guide plate 3. The light source from the cold cathode-ray tube 2 is reflected by the light guide plate 1, the reflection plate 3 and the light diffusion films 4 to output from the adapted liquid crystal cell 5 to be used by the LCD. The glow intensity of the LCD is approximately of 2000 cd/cm2. However, such side backlighting module fails to satisfy the light source required by the large size LCD. Instead, a down backlighting module as illustrated in FIG. 2 is used. Wherein, multiple cold cathode-ray tubes 7 are provided in a reflective mask 6 and multiple light diffusion films 8 are disposed between cold cathode-ray tubes 7 and liquid crystal cell 9. Once each cold cathode-ray tube 7 illuminates, the light source emits directly toward the liquid crystal cell 9 through the light diffusion films 8 to provide the light source required by the large size LCD. The carrying of multiple cold cathode-ray tubes 7 and elimination of loss due to the absence of the light guide plate as the medium for light source input and output. The down backlighting module for providing a glow intensity of 10000 cd/cm2 is very welcome by the industry.

However, leakage and source supply problems are observed with the down backlighting module upon being activated for operation because that those cold cathode-ray tubes get too closed to one another and the cold cathode-ray by nature is of high voltage and high frequency. All these problems are caused by the failure to control the voltage phase of the power supplied, resulting in that the phase shift of each pair of abutted cold cathode-ray tubes is not consistent. Such inconsistency in phase shift explains the larger leakage, and even the extent of leakage varies since the phase shift is not consistent, leading further to the unstable condition of the down backlighting module in general. All these problems are for the drive circuit (inverter) of the cold cathode-ray tube 7 has to overcome. One of the options is to have a synchronous drive circuit of the inverter for overcoming the leakage due to inconsistent phase shift of each load (i.e. the cold cathode-ray tube) when activated. As illustrated in FIG. 3, an extremely large source power must be provided by the power supplied to satisfy the demand at maximal output. In case of unstable source resulted from activation, the voltage could fluctuate to damage the efficacy of all the devices, reduce their service life, and in serious case, the general quality of the LCD.

### SUMMARY OF THE INVENTION

The present invention is related to a cold cathode-ray tube driving method applied in carrying multiple cold cathode-ray tubes, and more particularly, to one that is applied in driving cold cathode-ray tubes of a down backlighting module in a large size LCD.

The primary purpose of the present invention is to provide a driving method for a cold cathode-ray tube that achieves a highly stable power supplied and effective control of leakage due to inconsistent phase shift of each cold cathode-ray tube. To achieve the purpose, a voltage with a fixed phase shift is used to drive the cold cathode-ray to allow a fixed phase shift formed between any given pair of abutted cold cathode-ray tubes.

The foregoing object and summary provide only a brief introduction to the present invention. To fully appreciate these and other objects of the present invention as well as the invention itself, all of which will become apparent to those skilled-in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a structure of the prior art with a side backlighting module;

FIG. 2 is a schematic view showing another structure of the prior art with a down backlighting module;

FIG. 3 is a power chart of a synchronous circuit of the prior art;

FIG. 4 is a circuit drawing of the present invention using a D-type flip-flop;

FIG. 5 is a view showing a preferred embodiment of the present invention; and

FIG. 6 is a source output power chart of the preferred embodiment of the present invention.

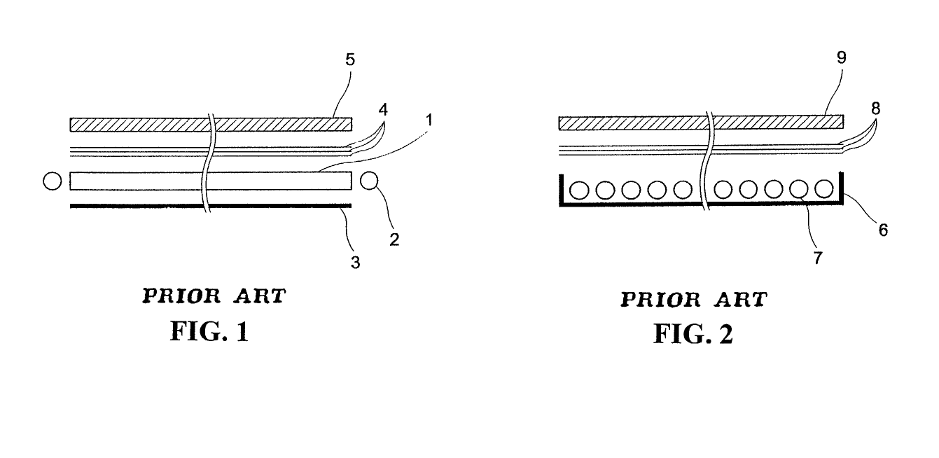

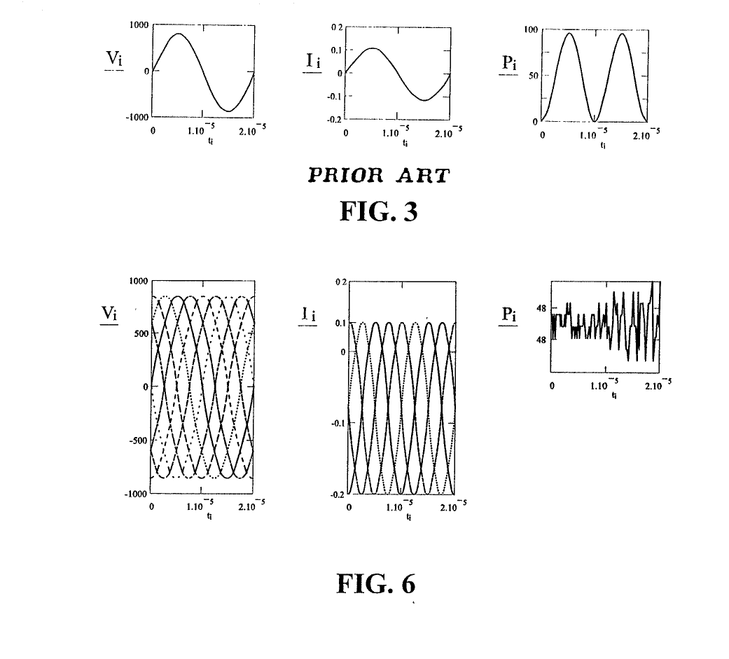

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

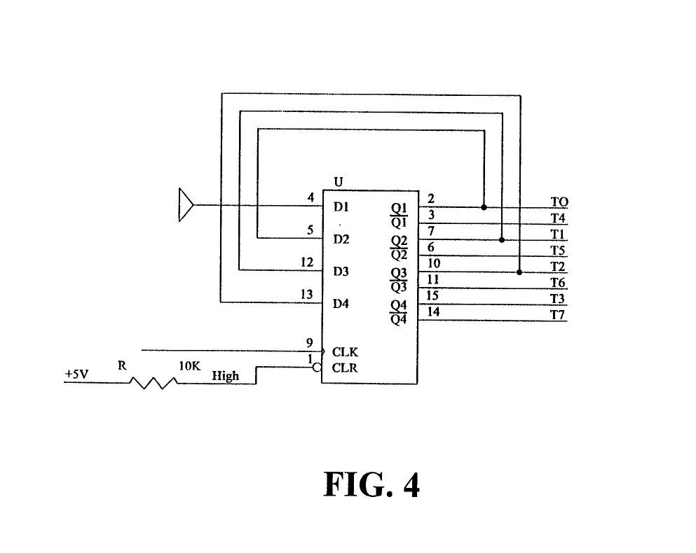

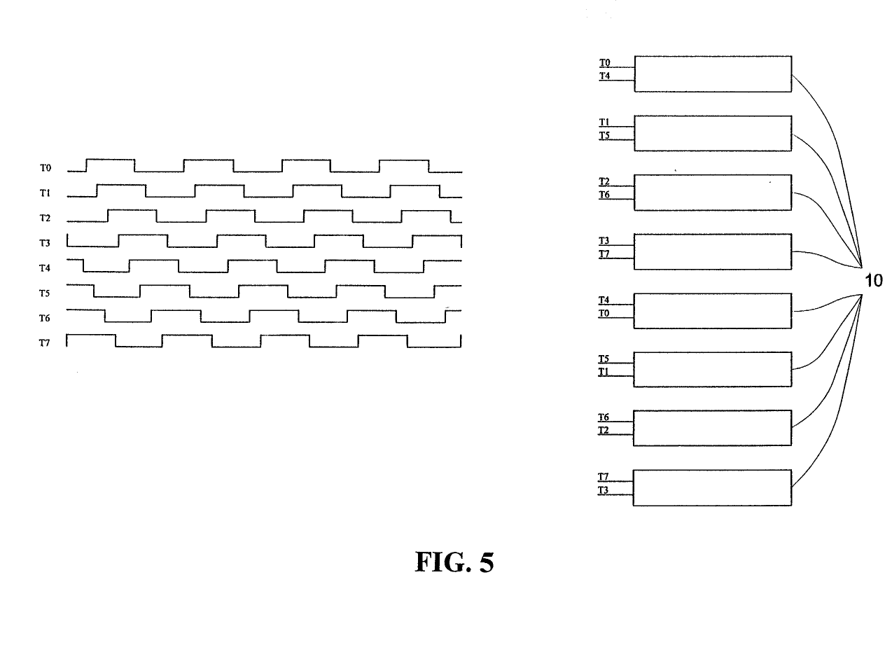

The present invention relates to a driving method applied in carrying multiple cold cathode-ray tubes (T), and more particularly to one applied in drying those cold cathode-ray tubes of down backlighting module in large size LCD. Instead of having the inverter circuit designed as a synchronous circuit in the prior art, the driving inverter of the present invention is designed to drive each load by means of a voltage with a fixed phase shift. When each inverter 10 drives the cold cathode-ray tube (T) it carries, a fixed phase shift is provided to each pair of abutted cold cathode-ray tubes (T). In practice, there are many options for the design of the circuit with fixed phase shift, e.g., the use of a D-type flip-flop as illustrated in FIG. 4 or other digital control means is sufficient. Therefore, the driving means by a voltage with a fixed phase shift will not be repeated in the subsequent description herein. Furthermore, once the power with a fixed phase shift is supplied to each cold cathode-ray tube T, it is found that judging from the wave form as illustrated in FIG. 5, the proper matching positions for the inverter 10 and the cold cathode-ray tube T can be selected. Therefore, given with the fact that each pair of abutted cold cathode-ray tubes T being formed with a phase shift, and said phase shift being of equal value, the power of the source required when those cold cathode-ray tubes T are activated will be significantly reduced for a successful driving as illustrated in FIG. 6. Meanwhile, the leakage is also significantly reduced to an acceptable range. As a result, the present invention while effectively solving the serious leakage found with the prior art due to failure in controlling the phase shift, eliminates the defective of the service life of all devices being affected by an extremely large surge upon activation of the prior art due to a source with much higher power is required in the application of the synchronous circuit.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cold cathode-ray tube driving method to be used for multiple cold cathode-ray tubes of a backlighting module in a large size LCD, characterized by having provided a fixed phase shift between each pair of abutted cold cathode-ray tubes to drive those multiple cold cathode-ray tubes without requiring extremely large source while minimizing leakage.
